(19) United States
(12) Patent Application Publication
(10) Pub. No.: US 2013/0067254 A1
(43) Pub. Date: Mar. 14, 2013

(54) HOST COMPUTER AND METHOD FOR TRANSMITTING DATA BETWEEN HOST COMPUTER AND SLAVE DEVICE

(71) Applicants: HSIEN-CHUAN LIANG, Tu-Cheng (TW); CHIH-CHUNG SHIH, Tu-Cheng (TW); SHOU-KUO HSU, Tu-Cheng (TW); YUNG-CHIEH CHEN, Tu-Cheng (TW)

(72) Inventors: HSIEN-CHUAN LIANG, Tu-Cheng (TW); CHIH-CHUNG SHIH, Tu-Cheng (TW); SHOU-KUO HSU, Tu-Cheng (TW); YUNG-CHIEH CHEN, Tu-Cheng (TW)

(73) Assignee: HON HAI PRECISION INDUSTRY CO., LTD., Tu-Cheng (TW)

(21) Appl. No.: 13/484,287

(22) Filed: May 31, 2012

(30) Foreign Application Priority Data
Sep. 8, 2011 (TW) 100132349

(51) Int. Cl. G06F 1/26

(52) U.S. Cl. 713/310

(57) ABSTRACT

In a method for transmitting data between a host computer and a slave device, the host computer connects to a slave device through a data communication port. The slave device is equipped with a power supply that includes at least one capacitor. The power supply is charged through the host computer using the capacitor when the host computer is powered on. The method controls the host computer sends data to the slave device, and controls the capacitor to discharge to provide power to the slave device for a period of time when the host computer is powered off, and stores the data packet into the slave device during the period of time. The method further retrieves the data from the storage device when the host computer is powered on, and resends the data to the slave device through the data communication port.

### BACKGROUND

1. Technical Field

Embodiments of the present disclosure relate to data transmission systems and methods, and particularly to a host computer, a storage medium, and a method for transmitting data between the host computer and a slave device.

2. Description of Related Art

One or more slave devices, such as hard disk drives, are attached to a host computer for storing large amounts of data. To ensure the integrity of the data stored in a slave device, the host computer may detect data transmission errors of the data using a checksum method; however, either the host computer or the slave device may be accidentally powered off during the data transmission between the host computer and a slave device. In such cases, the checksum method cannot check whether the data has been stored in the slave device completely, and thus the integrity of the data stored in the slave device cannot be ensured.

### BRIEF DESCRIPTION OF THE DRAWINGS

FIG. 1 is a block diagram of one embodiment of a host computer including a data transmission system.

FIG. 2 is a flowchart of one embodiment of a method for transmitting data between the host computer and the slave device of FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

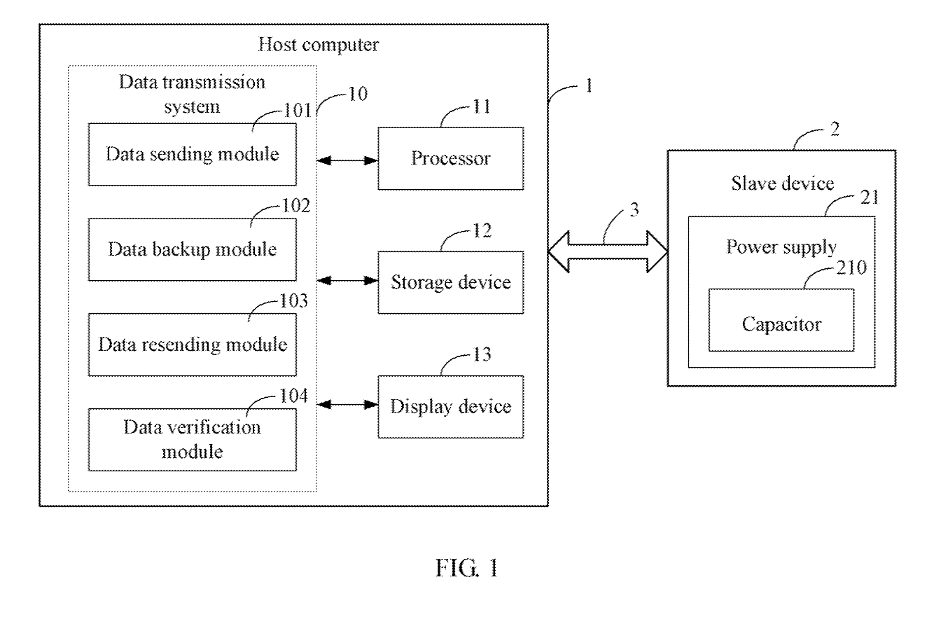

FIG. 1 is a block diagram of one embodiment of a host computer 1 including a data transmission system 10. In the embodiment, the host computer 1 may further include at least one processor 11, a storage device 12, and a display device 13. The host computer 1 connects to a slave device 2 through a data communication port 3, such as a serial attached small computer system (SAS) port or a serial advanced technology attachment (SATA) port. The host computer 1 may be a personal computer, a server, or any other data processing device. The slave device 2 may be a hard disk drive or a storage device for storing data transmitted from the host computer 1.

In one embodiment, the slave device 2 comprises a power supply 21, which includes at least one capacitor 210 having a charge and discharge function. The capacitor 210 charges through the host computer 1 when the host computer 1 is powered on, and discharges when the host computer 1 is powered off, to provide power to the slave device 2. As such, if the host computer 1 is transferring data to the slave device 2 and unexpectedly powers off during the data transfer, the data transmitted from the host computer 1 can be stored into the slave device 2 when the host computer 1 powers on again.

The data transmission system 10 may include a plurality of functional modules that are stored in the storage device 12 and executed by the at least one processor 11. In one embodiment, the storage device 12 may be an internal storage system, such as a random access memory (RAM) for temporary storage of information, and/or a read only memory (ROM) for permanent storage of information. The storage device 12 may also be an external storage system, such as an external hard disk, a storage card, or a data storage medium. The display device 13 displays prompt information when the host computer 1 does not completely transmit data to the slave device 2.

In one embodiment, the data transmission system 10 includes a data sending module 101, a data backup module 102, a data resending module 103, and a data verification module 104. The modules 101-104 may comprise computerized instructions in the form of one or more programs that are stored in the storage device 12 and executed by the at least one processor 11. In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as an EPROM. The modules described herein may be implemented as either software and/or hardware modules and may be stored in any type of non-transitory computer-readable medium or other storage device. Some non-limiting examples of non-transitory computer-readable medium include CDs, DVDs, flash memory, and hard disk drives.

The data sending module 101 controls the power supply 21 to charge through the host computer 1 using the capacitor 210 when the host computer 1 is powered on, obtains data from the storage device 12, and generates a verification code according to the data. In the embodiment, the verification code is a checksum code for checking data errors during the data transmission between the host computer 1 and the slave device 2. The data sending module 101 generates a data packet by packing the verification code into the data, and sends the data packet to the slave device 2 through the data communication port 3.

The data backup module 102 monitors whether the host computer 1 is powered on or powered off during the data transmission between the host computer 1 and the slave device 2. When the host computer 1 is powered off, the data backup module 102 controls the capacitor 210 of the power supply 20 to discharge which provides power for the slave device 2 for a period of time (e.g., 2 seconds), and stores the data packet into the slave device 2 during the period of time. The data backup module 102 further records an interruption tag of the data packet when the host computer 1 is powered off. In the embodiment, the interruption tag indicates which data of the data packet errs when the host computer 1 is powered off.

The data resending module 103 retrieves the data from the storage device 12 according to the interruption tag when the host computer 1 is powered on after being powered off, and resends the data to the slave device 2 through the data communication port 3. In the embodiment, the data resending module 103 may retrieve a first data packet from the storage device 12 before the interruption tag, and retrieve a second data packet from the storage device 12 after the interruption tag, and resends the first data packet and the second data packet to the slave device 2 through the data communication port 3. The first data packet and the second data packets indicating which data packets has erred.

The data verification module 104 determines whether the verification code of the slave device 2 is correct by checking whether the verification code of the host computer 1 is identical to the verification code of the slave device 2. If the verification code of the slave device 2 is incorrect, the host computer 1 resends the data to the slave device 2. If the host computer 1 does not resend data to the slave device 2, the data verification module 104 displays information on the display device 13 that indicates the host computer 1 does not completely transmit the data to the slave device 2.

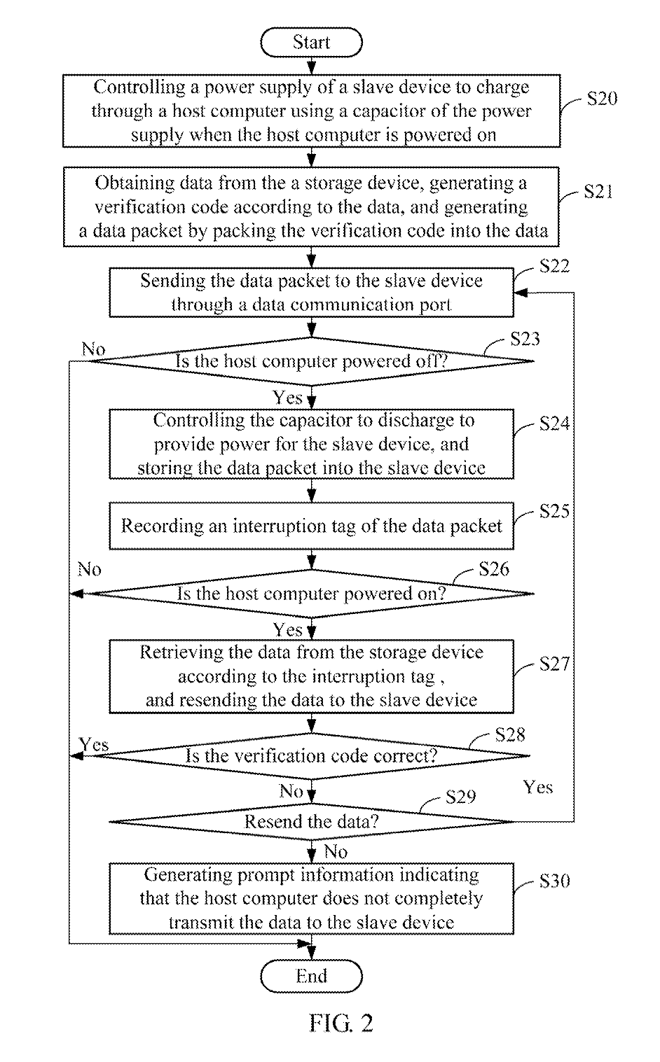

FIG. 2 is a flowchart of one embodiment of a method for transmitting data between the host computer 1 and the slave device 2 of FIG. 1. Depending on the embodiment, additional steps may be added, others removed, and the ordering of the steps may be changed.

In step S20, the data sending module 101 controls the power supply 21 of the slave device 2 to charge through the host computer 1 using the capacitor 210 when the host computer 1 is powered on. In one embodiment, the capacitor 210 charges through the host computer 1 when the host computer 1 is powered on, and discharges to provide power to the slave device 2 when the host computer 1 is powered off.

In step S21, the data sending module 101 obtains data from the storage device 12, and generates a verification code according to the data. In one embodiment, the verification code is a checksum code for checking data errors during the data transmission between the host computer 1 and the slave device 2.

In step S22, the data sending module 101 generates a data packet by packing the verification code into the data, and sends the data packet to the slave device 2 through the data communication port 3. In one embodiment, the verification code can be packed into a header of the data packet.

In step S23, the data backup module 102 determines whether the host computer 1 is powered off during the data transmission between the host computer 1 and the slave device 2. If the host computer 1 is powered off, the step S24 is implemented. If the host computer 1 is powered on, the flow goes to end.

In step S24, the data backup module 102 controls the capacitor 210 of the power supply 20 to discharge to provide power for the slave device 2 for a period of time (e.g., 2 seconds), and stores the data packet into the slave device 2 during the period of time.

In step S25, the data backup module 102 records an interruption tag of the data packet when the host computer 1 is powered off. In the embodiment, the interruption tag indicates which data of the data packet occurs errors when the host computer 1 is powered off.

In step S26, the data backup module 102 determines whether the host computer 1 is powered on. If the host computer 1 is powered on again, the step S27 is implemented. If the host computer 1 is still not powered on, the flow goes to end.

In step S27, the data resending module 103 retrieves the data from the storage device 12 according to the interruption tag, and resends the data to the slave device 2 through the data communication port 3. In the embodiment, the data resending module 103 may retrieve a first data packet before the interruption tag, and retrieve a second data packet after the interruption tag, and then resends the first data packet and the second data packet to the slave device 2 through the data communication port 3. The first data packet and the second data packets indicating which data packets has erred.

In step S28, the data verification module 104 determines whether the verification code of the slave device 2 is correct by checking whether the verification code of the host computer 1 is identical to the verification code of the slave device 2. If the verification code of the slave device 2 is incorrect, the step S39 is implemented. If the verification code of the slave device 2 is correct, the flow goes to end.

In step S29, the data verification module 104 determines whether the host computer 1 resends the data to the slave device 2 by checking whether the host computer 1 receives a data resending request from the slave device 2. If the host computer 1 resends the data to the slave device 2, the flow returns to step S22. Otherwise, if the host computer 1 does not resend the data to the slave device 2, the flow goes to step S30.

In step S30, the data verification module 104 displays information on the display device 13 indicating that the host computer 1 does not completely transmit the data to the slave device 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A host computer, the host computer electronically connected to a slave device through a data communication port, the computing device comprising:
a storage system;
at least one processor; and
one or more programs stored in the storage system and executable by the at least one processor, the one or more programs comprising:
a data sending module that controls a power supply of the slave device to charge through the host computer using a capacitor of the power supply when the host computer is powered on, obtains data from the storage device and generates a verification code according to the data, generates a data packet by packing the verification code into the data, and sends the data packet to the slave device through the data communication port;
a data backup module that controls the capacitor of the power supply to discharge to provide power for the slave device for a period of time when the host computer is powered off, stores the data packet into the slave device during the period of time, and records an interruption tag of the data packet;
a data resending module that retrieves the data from the storage device according to the interruption tag when the host computer is powered on again, and resends the data to the slave device through the data communication port; and
a data verification module that determines whether the verification code of the slave device is correct, and displays information on a display device of the host computer that indicates the host computer does not completely transmit the data to the slave device, if the verification code of the slave device is incorrect.

2. The computing device according to claim 1, wherein the verification code is a checksum code for checking whether there are errors in the data packet in response to the host computer being powered off, and the interruption tag indicates which data of the data packet has erred.

3. The computing device according to claim 1, wherein data backup module further monitors whether the host computer is powered on or powered off during a data transmission between the host computer and the slave device.

4. The computing device according to claim 1, wherein data resending module retrieves a first data packet from the storage device before the interruption tag, retrieves a second data packet from the storage device after the interruption tag, and resends the first data packet and the second data packet to the slave device through the data communication port.

5. The computing device according to claim 1, wherein the data verification module determines whether the verification code of the slave device is correct by checking whether the verification code of the host computer is identical to the verification code of the slave device.

6. The computing device according to claim 5, wherein the data verification module further determines whether the host computer resends the data to the slave device when the verification code of the slave device is incorrect.

7. A method for transmitting data between a host computer and a slave device, the method comprising:
controlling a power supply of the slave device to charge through the host computer using a capacitor of the power supply when the host computer is powered on;
obtaining data from a storage device of the host computer, generating a verification code according to the data, and generating a data packet by packing the verification code into the data;
sending the data packet to the slave device through a data communication port between the host computer and the slave device;
controlling the capacitor of the power supply to discharge to provide power for the slave device for a period of time when the host computer is powered off;
storing the data packet into the slave device during the period of time, and recording an interruption tag of the data packet;
retrieving the data from the storage device according to the interruption tag when the host computer is powered on, and resending the data to the slave device through the data communication port;
determining whether the verification code of the slave device is correct; and
displaying information on a display device of the host computer that indicates the host computer does not completely transmit the data to the slave device, if the verification code of the slave device is incorrect.

8. The method according to claim 7, wherein the verification code is a checksum code for checking whether there are errors in the data packet in response to the host computer being powered off, and the interruption tag indicates which data of the data packet has erred.

9. The method according to claim 7, further comprising:
monitoring whether the host computer is powered on or powered off during a data transmission between the host computer and the slave device.

10. The method according to claim 7, further comprising:
retrieving a first data packet from the storage device before the interruption tag;
retrieving a second data packet from the storage device after the interruption tag; and
resending the first data packet and the second data packet to the slave device through the data communication port.

11. The method according to claim 7, wherein the verification code of the slave device is determined to be correct or incorrect by checking whether the verification code of the host computer is identical to the verification code of the slave device.

12. The method according to claim 11, further comprising:
determining whether the host computer resends the data to the slave device if the verification code of the slave device is incorrect.

13. A non-transitory computer-readable storage medium having stored thereon instructions that, when executed by at least one processor of a host computer, causes the host computer to perform a method for transmitting data between the host computer and a slave device, the method comprising:
controlling a power supply of the slave device to charge through the host computer using a capacitor of the power supply when the host computer is powered on;
obtaining data from a storage device of the host computer, generating a verification code according to the data, and packing the verification code into the data to generate a data packet;
sending the data packet to the slave device through a data communication port between the host computer and the slave device;
controlling the capacitor of the power supply to discharge to provide power for the slave device for a period of time when the host computer is powered off;
storing the data packet into the slave device during the period of time, and recording an interruption tag of the data packet;
retrieving the data from the storage device according to the interruption tag when the host computer is powered on, and resending the data to the slave device through the data communication port;
determining whether the verification code of the slave device is correct; and
displaying information on a display device of the host computer that indicates the host computer does not completely transmit the data to the slave device, if the verification code of the slave device is incorrect.

14. The storage medium according to claim 13, wherein the verification code is a checksum code for checking whether there are errors in the data packet in response to the host computer being powered off, and the interruption tag indicates which data of the data packet has erred.

15. The storage medium according to claim 13, wherein the method further comprises:
monitoring whether the host computer is powered on or powered off during a data transmission between the host computer and the slave device.

16. The storage medium according to claim 13, wherein the method further comprises:
retrieving a first data packet from the storage device before the interruption tag;
retrieving a second data packet from the storage device after the interruption tag; and
resending the first data packet and the second data packet to the slave device through the data communication port.

17. The storage medium according to claim 13, wherein the verification code of the slave device is determined to be correct or incorrect by checking whether the verification code of the host computer is identical to the verification code of the slave device.

18. The storage medium according to claim 17, wherein the method further comprises:
determining whether the host computer resends the data to the slave device if the verification code of the slave device is incorrect.
